(19) United States
(12) Patent Application Publication
(10) Pub. No.: US 2025/0219419 A1
(43) Pub. Date: Jul. 3, 2025

(54) CONTROL METHOD AND SYSTEM FOR AVC SUBSTATION REACTIVE POWER OPTIMIZATION ASSISTANCE

(71) Applicants: Guangdong Power Grid Co Ltd., Guangzhou City (CN); Maoming Power Supply Bureau of Guangdong Power Grid Co Ltd., Maoming City (CN)

(72) Inventors: Jiazhong BI, Guangzhou City (CN); Renli YANG, Maoming City (CN); Xiwu WU, Maoming City (CN); Yixin ZHANG, Maoming City (CN); Zihou HU, Maoming City (CN); Juntao ZHOU, Maoming City (CN); Wen CHEN, Maoming City (CN); Runquan HE, Maoming City (CN); Jianyuan XU, Maoming City (CN); Shusi WU, Maoming City (CN); Huahao YANG, Maoming City (CN); Lanhao LI, Maoming City (CN); Yifan LIU, Maoming City (CN); Xiaotong DENG, Maoming City (CN); Jiayin HAO, Maoming City (CN)

(73) Assignees: Guangdong Power Grid Co Ltd., Guangzhou City (CN); Maoming Power Supply Bureau of Guangdong Power Grid Co Ltd., Maoming City (CN)

(21) Appl. No.: 19/004,077

(22) Filed: Dec. 27, 2024

(30) Foreign Application Priority Data
Dec. 27, 2023 (CN) 202311832203.2

(51) Int. Cl. H02J 3/18; H02J 13/00

(52) U.S. Cl. CPC H02J 3/1835; H02J 13/00001; H02J 13/00002

(57) ABSTRACT

A control method and system for automatic voltage control (AVC) substation reactive power optimization assistance are provided, and belong to the technical field of electric power system operation control. The method includes: determining whether a reactive integrated electric quantity of a main transformer step-down switch of a substation exceeds a set value of reactive integrated electric quantity of the main transformer step-down switch; if yes, determining whether voltage of a 10 kV bus of the substation is qualified; if yes, determining whether a power factor of a transformer step-down switch is greater than a power factor set value of the main transformer step-down switch; if yes, determining whether a reactive power demand of the substation is true; and if yes, putting a capacitor into use to perform reactive on-site balance control.

### TECHNICAL FIELD

The present disclosure belongs to the technical field of electric power system operation control, and specifically, to a control method and system for substation reactive power optimization assistance based on a dispatching automatic voltage control (AVC) substation system.

### BACKGROUND

An automatic voltage control (AVC) function is to: acquire, monitor, calculate, and analyze real-time reactive voltage operation information of a regional power grid, control an operation state of a reactive voltage device in the power grid based on satisfying safe and stable operation of the power grid, provide a technology for voltage safety, high quality, and economic operation based on an energy management system (EMS)/supervisory control and data acquisition (SCADA) system, maintain voltage operation within a qualified range, optimize reactive power distribution of a dispatching AVC substation, and reduce loss of the power grid.

After voltage of a 10 kV bus of an existing automatic voltage control (AVC) substation exceeds a limit and a capacitor is cut off, the current AVC substation control strategy fails to give full play to energy saving and consumption reduction.

### SUMMARY

The present disclosure provides the following technical solutions:

In a first aspect, the present disclosure provides a control method for AVC substation reactive power optimization assistance, including:
whether a reactive integrated electric quantity of a main transformer step-down switch of a substation exceeds a set value of reactive integrated electric quantity of the main transformer step-down switch is determined;
in a case that the reactive integrated electric quantity of the main transformer step-down switch of the substation exceeds the set value of reactive integrated electric quantity of the main transformer step-down switch, whether voltage of a 10 kV bus of the substation is qualified is determined;
in a case that the voltage of the 10 kV bus of the substation is qualified, whether a power factor of a transformer step-down switch is greater than a power factor set value of the main transformer step-down switch is determined;
in a case that the power factor of the transformer step-down switch is greater than the power factor set value of the main transformer step-down switch, whether a reactive power demand of the substation is true is determined; and in a case that the reactive power demand of the substation is true, a capacitor is put into use to perform reactive on-site balance control.

In some embodiments, a qualification range of the voltage of the 10 kV bus of the substation is 10.2 kV to 10.7 kV.

In some embodiments, a calculation formula of the power factor is as follows:

$$cos φ = P / S ,$$

and cosφ represents the power factor; P represents active power of the main transformation step-down switch; and S represents apparent power of the main transformation step-down switch.

In some embodiments, a calculation formula of the apparent power is as follows:

$$S = \sqrt{{P}^{2} + {Q}^{2}} ,$$

and Q represents reactive power of the main transformation step-down switch.

In some embodiments, the reactive power demand of the substation is determined according to the following condition:
a main transformer ride-through reactive power value is over 90% of a group of capacitance value of the 10 kV bus.

In a second aspect, the present disclosure provides a control system for AVC substation reactive power optimization assistance, including:
a first determining unit, configured to determine whether a reactive integrated electric quantity of a main transformer step-down switch of a substation exceeds a set value of reactive integrated electric quantity of the main transformer step-down switch, and in a case that the reactive integrated electric quantity of the main transformer step-down switch of the substation exceeds the set value of reactive integrated electric quantity of the main transformer step-down switch, enter a second determining unit;
the second determining unit, configured to determine whether voltage of a 10 kV bus of the substation is qualified, and in a case that the voltage of the 10 kV bus of the substation is qualified, enter a third determining unit;
the third determining unit, configured to determine whether a power factor of a transformer step-down switch is greater than a power factor set value of the main transformer step-down switch, and in a case that the power factor of the transformer step-down switch is greater than the power factor set value of the main transformer step-down switch, enter a fourth determining; and
the fourth determining unit, configured to: determine whether a reactive power demand of the substation is true; and in a case that the reactive power demand of the substation is true, put a capacitor into use to perform reactive on-site balance control.

In some embodiments, a qualification range of the voltage of the 10 kV bus of the substation is 10.2 kV to 10.7 kV.

In some embodiments, a calculation formula of the power factor is as follows:

$$cos φ = P / S ,$$

and cosφ represents the power factor; P represents active power of the main transformation step-down switch; and S represents apparent power of the main transformation step-down switch.

Correspondingly, the present disclosure provides a computer device, including: a memory, a processor, and a computer program stored on the memory. The computer program, when run by the processor, implements the control method for AVC substation reactive power optimization assistance as described in the first aspect.

Correspondingly, the present disclosure provides a computer storage medium, having a computer program stored thereon. The computer program, when run by a processor, implements the control method for AVC substation reactive power optimization assistance as described in the first aspect.

### BRIEF DESCRIPTION OF THE DRAWINGS

To describe the technical solutions in the embodiments of the present disclosure or in the related art more clearly, the following briefly introduces the accompanying drawings for describing the embodiments or the related art. Apparently, the accompanying drawings in the following description show merely some embodiments of the present disclosure, and a person of ordinary skill in the art may still derive other drawings from the accompanying drawings without creative efforts.

FIG. 1 is a flowchart of a control method for AVC substation reactive power optimization assistance according to an embodiment of the present disclosure;

FIG. 2 is a structural diagram of AVC substation reactive power optimization assistance according to an embodiment of the present disclosure;

FIG. 3 is a structural diagram of a control system for AVC substation reactive power optimization assistance according to an embodiment of the present disclosure; and

FIG. 4 is a structural diagram of a computer device according to an embodiment of the present disclosure.

### DETAILED DESCRIPTION OF EMBODIMENTS

In order to make the objectives, features, and advantages of the present disclosure more obvious and understandable, the technical solutions in the embodiments of the present disclosure will be clearly and completely described below with reference to the drawings in the embodiments of the present disclosure, and it is obvious that the embodiments described below are only a part of the embodiments of the present disclosure but not all of them. All other embodiments obtained by a person of ordinary skill in the art based on the embodiments of present disclosure without making creative efforts shall fall within the protection scope of present disclosure.

At present, an AVC substation control strategy mainly considers a voltage qualification range and a transformer power factor qualification range, as well as a protection blocking signal that affects device operation. This control strategy follows the principle of voltage priority. A substation controls a reactive power device to track an in-station voltage curve. After voltage of a 10 kV bus of an AVC substation exceeds a limit and a capacitor is cut off, a reactive power ride-through value of a transformer is greater than a capacitance value of the bus; under a condition that 10 kV voltage is qualified, an AVC substation strategy fails to be put into use on the capacitor of the bus, thus lacking voltage qualification condition as well as on-site reactive power balancing measure, and a role in energy conservation and consumption reduction is not achieved.

In view of this, the present disclosure aims to solve the above problems caused after voltage of a 10 kV bus of an existing automatic voltage control (AVC) substation exceeds a limit and a capacitor is cut off.

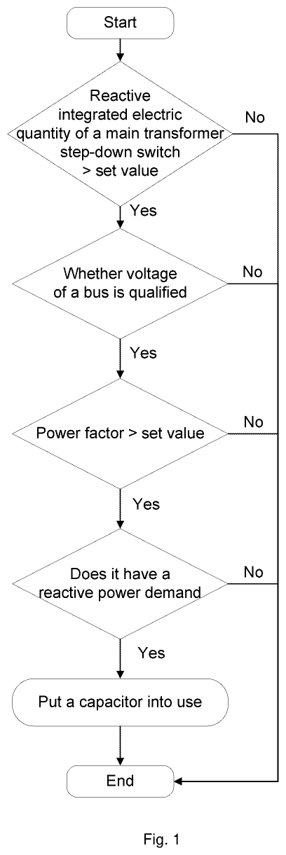

Referring to FIG. 1, this embodiment provides a control method for AVC substation reactive power optimization assistance, including:

Step I: whether a reactive integrated electric quantity of a main transformer step-down switch of a substation exceeds a set value of reactive integrated electric quantity of the main transformer step-down switch is determined.

It should be noted that an AVC substation is a local control apparatus or software operating in a power plant or a transformer substation, and is configured to: receive and execute control instructions of a master station and feedback information to the master station. The substation executes specific adjustment instructions provided by the master station of a capacitor, a reactor, and an on-load voltage adjustment tap.

In this step, the substation remotely measures reactive power data of the transformer step-down switch is used to obtain 24-hour reactive supervisory control and data acquisition (SCADA) integrated electric quantity of the main transformer step-down switch. The integrated electric quantity value is compared with a set value (which may be 2 Mvar) of reactive integrated electric quantity of the main transformer step-down switch. If the integrated electric quantity value exceeds the set value, subsequent steps are executed.

Step II: in a case that the reactive integrated electric quantity of the main transformer step-down switch of the substation exceeds the set value of reactive integrated electric quantity of the main transformer step-down switch, whether voltage of a 10 kV bus of the substation is qualified is determined.

It should be noted that when the voltage of the 10 kV bus of the substation is within a qualification range, it is considered that the voltage of the 10 kV bus of the substation is qualified. In an embodiment of the present disclosure, a qualification range of the voltage of the 10 kV bus of the substation is 10.2 kV to 10.7 kV.

Step III: in a case that the voltage of the 10 kV bus of the substation is qualified, whether a power factor of a transformer step-down switch is greater than a power factor set value of the main transformer step-down switch is determined.

It should be noted that the power factor means a ratio of active power of an alternating current circuit to apparent power of the alternating current circuit. At a certain voltage and power, if the power factor is larger, an electrical device of a user has better benefits, and a power generation device may be better fully used.

The power factor of the main transformer step-down switch is calculated according to data remotely measured by the substation, with a reference value of 0.1.

In an embodiment, a calculation formula of the power factor of the transformer step-down switch is as follows:

$$cos φ = P / S ,$$

and cosφ represents the power factor; P represents active power of the main transformation step-down switch; and S represents apparent power of the main transformation step-down switch.

A calculation formula of the apparent power is as follows:

$$S = \sqrt{{P}^{2} + {Q}^{2}} ,$$

and Q represents reactive power of the main transformation step-down switch.

A power transportation formula is set as follows: a directional multiplication result of P and Q×absolute value of the power factor, namely, formula: power factor=(directional multiplication result of P and Q)×|cosφ|. If the calculated value of this formula exceeds the power factor set value of the main transformer step-down switch, such as 0.1, the subsequent step is executed.

Step IV: in a case that the power factor of the transformer step-down switch is greater than the power factor set value of the main transformer step-down switch, whether a reactive power demand of the substation is true is determined, and in a case that the reactive power demand of the substation is true, a capacitor is put into use to perform reactive on-site balance control.

In summary, the present disclosure provides a control method and system for AVC substation reactive power optimization assistance. The method includes: whether a reactive integrated electric quantity of a main transformer step-down switch of a substation exceeds a set value of reactive integrated electric quantity of the main transformer step-down switch is determined; if yes, whether voltage of a 10 kV bus of the substation is qualified is determined; if yes, whether a power factor of a transformer step-down switch is greater than a power factor set value of the main transformer step-down switch is determined; if yes, whether a reactive power demand of the substation is true is determined; and if yes, a capacitor is put into use to perform reactive on-site balance control. According to the method, under a condition that voltage is qualified, a reactive power demand of the 10 kV bus of the main transformer step-down switch may be calculated. When a reactive power optimization assistance control condition is true, a capacitor is put into use according to the reactive power demand of the 10 kV bus, thereby achieving reactive on-site balance on a transformer substation, and reducing power grid loss caused by long-distance transmission of reactive power.

It should be noted that the reactive power data of the transformer step-down switch are remotely measured by the substation, when a direction of data acquired by dispatching automation is the same, reactive power input to the bus is negative, reactive power output from the bus is positive, and a capacitance value of the 10 kV bus is positive.

A reactive power determining formula is set as follows: reactive power of the transformer step-down switch+the group of capacitance value of the 10 kV bus. If the calculated value of this formula is less than the set value, such as 0.1 Mvar, namely, if reactive power=reactive power of the transformer step-down switch+the group of capacitance value of the 10 kV bus<0.1 Mvar, it indicates that a main transformer ride-through reactive power value is over 90% of a group of capacitance value of the 10 kV bus, the reactive power demand of the substation is true, and a capacitor is put into use.

It should be noted that the way of performing reactive on-site balance control is to put the capacitor into use.

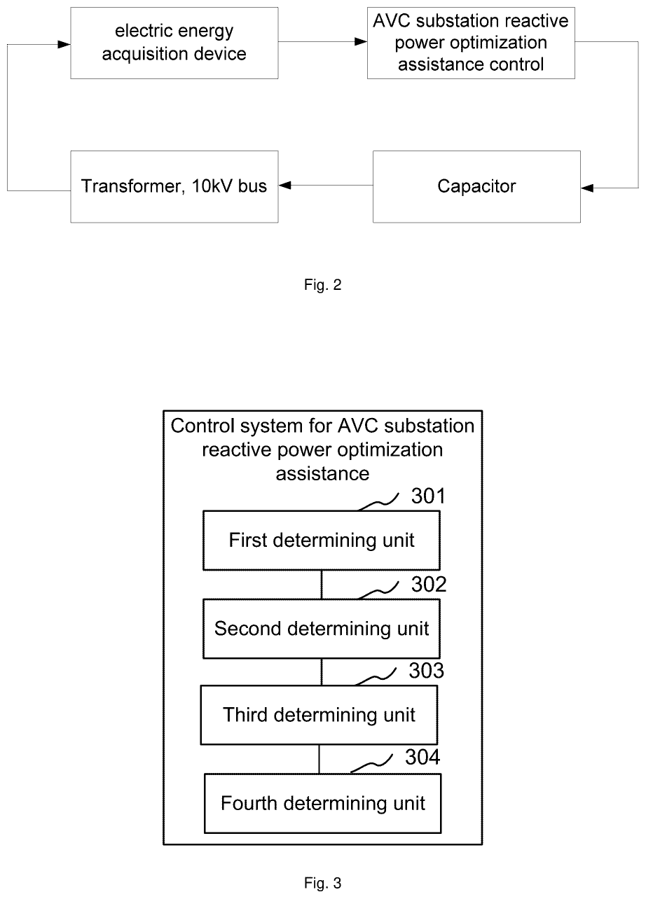

As shown in FIG. 2, a structural diagram of AVC substation reactive power optimization assistance is composed of a transformer 10 kV bus, an electric energy acquisition device, AVC substation reactive power optimization assistance, and a capacitor. The reactive power integrated electric quantity of the transformer step-down switch, the power factor, the reactive power, the capacitance value of the 10 kV bus, and the voltage data of the 10 kV bus are acquired to the electric energy acquisition device. Through a reactive power optimization assistance program of a computer, based on the data acquired by this substation, the acquired data is analyzed and calculated to determine the reactive power demand of the 10 kV bus. Based on the electrical quantity data acquired by this substation and state data corresponding to characteristics of the reactive power data, through a calculation program for the reactive power demand of the 10 kV bus, the substation reactive power optimization assistance condition is true, and the capacitor is put into use to achieve reactive on-site balance.

This embodiment provides a control method for AVC substation reactive power optimization assistance. Under the condition that the voltage is qualified, the reactive power demand of the 10 kV bus of the main transformer step-down switch may be calculated. When the reactive power optimization assistance control condition is true, the capacitor is put into use according to the reactive power demand of the 10 kV bus, thereby achieving reactive on-site balance on a transformer substation, and reducing power grid loss caused by long-distance transmission of reactive power.

Based on the same inventive concept, an embodiment of the present application further provides a control system for AVC substation reactive power optimization assistance using the control method for AVC substation reactive power optimization assistance. An implementation scheme provided by the system to solve the problem is similar to the implementation scheme recorded in the above method. Therefore, specific limitations in the following embodiment of the control system for AVC substation reactive power optimization assistance may be found in the limitations on the control method for AVC substation reactive power optimization assistance above, and will not be elaborated here.

Referring to FIG. 3, this embodiment provides a control system for AVC substation reactive power optimization assistance, including:
a first determining unit 301, determine whether a reactive integrated electric quantity of a main transformer step-down switch of a substation exceeds a set value of reactive integrated electric quantity of the main transformer step-down switch, and in a case that the reactive integrated electric quantity of the main transformer step-down switch of the substation exceeds the set value of reactive integrated electric quantity of the main transformer step-down switch, enter a second determining unit;
the second determining unit 302, configured to determine whether voltage of a 10 kV bus of the substation is qualified, and in a case that the voltage of the 10 kV bus of the substation is qualified, enter a third determining unit;
the third determining unit 303, configured to determine whether a power factor of a transformer step-down switch is greater than a power factor set value of the main transformer step-down switch, and in a case that the power factor of the transformer step-down switch is greater than the power factor set value of the main transformer step-down switch, enter a fourth determining; and
the fourth determining unit 304, configured to: determine whether a reactive power demand of the substation is true; and in a case that the reactive power demand of the substation is true, put a capacitor into use to perform reactive on-site balance control.

Further, a qualification range of the voltage of the 10 kV bus of the substation is 10.2 kV to 10.7 kV.

Further, a calculation formula of the power factor is as follows:

$$cos φ = P / S ,$$

and cosφ represents the power factor; P represents active power of the main transformation step-down switch; and S represents apparent power of the main transformation step-down switch.

A person skilled in the art can clearly know that for ease and simplicity of description, division of all the above functional units and modules is exemplified only. In practical applications, the foregoing functions may be allocated to be completed by different functional units and modules as required, that is, an inner structure of the system is divided into different functional units and modules, so as to complete all or some of the functions described above. The functional units and modules in the embodiments may be integrated into one processing unit, or each of the units may exist alone physically, or two or more units are integrated into one unit. The integrated unit described above may be implemented in the form of hardware or a software functional unit. In addition, the specific names of the various functional units and modules are only for the purpose of distinguishing them from each other and are not used to limit the protection scope of the present disclosure. For specific working processes of the units and modules in the system described above, refer to the corresponding processes in the foregoing method embodiments, and details are not described here again.

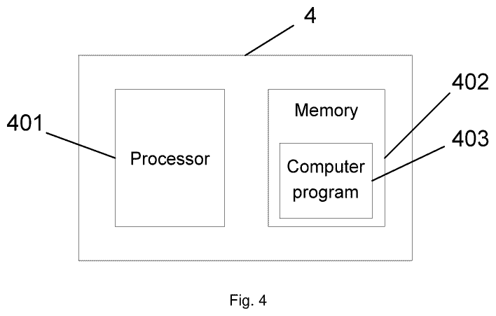

Referring to FIG. 4, an embodiment of the present disclosure further provides a computer device 4, including: a memory 402, a processor 401, and a computer program 403 stored on the memory 402. The computer program 403, when run on the processor 401, implements any control method for AVC substation reactive power optimization assistance in the above methods.

The computer device 4 may be a computing device, such as a desk computer, a notebook computer, a palmtop, and a cloud server. The computer device 4 may include, but is not limited to, the processor 401 and the memory 402. A person skilled in the art can understand that FIG. 4 is only an example of the computer device 4 and does not constitute a limitation on the computer device 4. It can include more or fewer components than those shown, or combinations of some components, or different components. For example, the computer device may further include an input and output device, a network access device, and the like.

The processor 401 may be a central processing unit (CPU), or may be other general-purpose processors, digital signal processors (DSPs), application-specific integrated circuits (ASICs), field-programmable gate arrays (FPGAs), or may be other programmable logic devices, discrete gates or transistor logic devices, and discrete hardware components. The general-purpose processor may be a microprocessor, or the processor may be any conventional processor, or the like.

The memory 402 may be an internal storage unit of the computer device 4, such as a hard disk drive or an internal memory of the computer device 4 in some embodiments. The memory 402 may be an external storage device of the computer device 4, such as a plug-in hard disk drive, a smart media card (SMC), an Secure Digital (SD) card, or a flash card that is equipped on the computer device 4, in some other embodiments. Further, the memory 402 may include both an internal storage unit of the computer device 4 and an external storage device. The memory 402 is configured to store an operating system, an application program, a bootloader, data, and other programs, such as a program code of a computer program. The memory 402 can also be configured to temporarily store data that has been or is about to be output.

An embodiment of the present disclosure further provides a computer-readable storage medium, having a computer program stored thereon. The computer program, when run by a processor, implements any control method for AVC substation reactive power optimization assistance in the above methods.

In this embodiment, when the integrated unit is implemented in the form of a software functional unit and sold or used as an independent product, the integrated unit may be stored in a computer-readable storage medium. Based on this understanding, the present application implements all or part of the flows in the method of the above embodiment, which may be completed by instructing relevant hardware through the computer program. The computer program may be stored in the computer-readable storage medium. When run by the processor, the computer program can achieve the steps of the method embodiments described above. The computer program includes computer program codes, and the computer program codes may be in the form of a source code, the form of an object code, an executable files, or some intermediate forms. The computer-readable medium may at least include any entity or apparatus capable of carrying a computer program code to a camera apparatus/terminal device, a recording medium, a computer memory, a read-only memory (ROM), a random access memory (RAM), an electric carrier signal, a telecommunication signal, and a software distribution medium, such as a USB flash disk, a portable hard disk drive, a magnetic disk, or a compact disc. In some jurisdictions, according to the legislation and patent practice, the computer-readable medium may not be an electric carrier signal and a telecommunication signal.

In the foregoing embodiments, the description of each embodiment has respective focuses. For a part that is not described in detail or recorded in an embodiment, reference may be made to related descriptions in other embodiments.

Those of skill in the art would recognize that the illustrative units and algorithm steps described in connection with the embodiments disclosed herein may be implemented as electronic hardware, or combinations of computer software and electronic hardware. Whether these functions are implemented as hardware or software depends on particular application and design constraint conditions of the technical solutions. A person skilled in the art may use different methods to implement the described functions for each particular application, but it should not be considered that the implementation goes beyond the scope of the present application.

In the embodiments of the present application, it should be understood that the disclosed apparatus/terminal device and method may be implemented in other manners. For example, the above-described apparatus/terminal device embodiments are merely illustrative. For example, the division of the modules or units is only one type of logical functional division, and other divisions are achieved in practice. For example, multiple units or components may be combined or integrated into another system, or some features may be omitted, or not executed. On the other hand, the mutual coupling or direct coupling or communication connection displayed or discussed may be indirect coupling or communication connection through some interface, device or unit, which may be electrical, mechanical or other forms.

The foregoing various embodiments are merely intended to describe the technical solutions of the present disclosure, but not for limiting the present disclosure. Although the present disclosure is described in detail with reference to the foregoing various embodiments, persons of ordinary skill in the art should understand that they may still make modifications to the technical solutions described in the foregoing embodiments or make equivalent replacements to partial technical features thereof. However, these modifications or replacements do not make the essence of the corresponding technical solutions depart from the scope of the technical solutions of the various embodiments of the present disclosure.

What is claimed is:

1. A control method for automatic voltage control (AVC) substation reactive power optimization assistance, comprising:
determining whether a reactive integrated electric quantity of a main transformer step-down switch of a substation exceeds a set value of reactive integrated electric quantity of the main transformer step-down switch;
in a case that the reactive integrated electric quantity of the main transformer step-down switch of the substation exceeds the set value of reactive integrated electric quantity of the main transformer step-down switch, determining whether voltage of a 10 kV bus of the substation is qualified;
in a case that the voltage of the 10 kV bus of the substation is qualified, determining whether a power factor of a transformer step-down switch is greater than a power factor set value of the main transformer step-down switch;
in a case that the power factor of the transformer step-down switch is greater than the power factor set value of the main transformer step-down switch, determining whether a reactive power demand of the substation is true; and in a case that the reactive power demand of the substation is true, putting a capacitor into use to perform reactive on-site balance control.

2. The control method for AVC substation reactive power optimization assistance according to claim 1, wherein a qualification range of the voltage of the 10 kV bus of the substation is 10.2 kV to 10.7 kV.

3. The control method for AVC substation reactive power optimization assistance according to claim 1, wherein a calculation formula of the power factor is as follows:
$$cos φ = P / S ,$$
wherein cosφ represents the power factor; P represents active power of the main transformation step-down switch; and S represents apparent power of the main transformation step-down switch.

4. The control method for AVC substation reactive power optimization assistance according to claim 3, wherein a calculation formula of the apparent power is as follows:
$$S = \sqrt{{P}^{2} + {Q}^{2}} ,$$
wherein Q represents reactive power of the main transformation step-down switch.

5. The control method for AVC substation reactive power optimization assistance according to claim 1, wherein the reactive power demand of the substation is determined according to the following condition:
a main transformer ride-through reactive power value is over 90% of a group of capacitance value of the 10 kV bus.

6. A control system for AVC substation reactive power optimization assistance, comprising:
a first determining unit, configured to determine whether a reactive integrated electric quantity of a main transformer step-down switch of a substation exceeds a set value of reactive integrated electric quantity of the main transformer step-down switch, and in a case that the reactive integrated electric quantity of the main transformer step-down switch of the substation exceeds the set value of reactive integrated electric quantity of the main transformer step-down switch, enter a second determining unit;
the second determining unit, configured to determine whether voltage of a 10 kV bus of the substation is qualified, and in a case that the voltage of the 10 kV bus of the substation is qualified, enter a third determining unit;
the third determining unit, configured to determine whether a power factor of a transformer step-down switch is greater than a power factor set value of the main transformer step-down switch, and in a case that the power factor of the transformer step-down switch is greater than the power factor set value of the main transformer step-down switch, enter a fourth determining; and
the fourth determining unit, configured to: determine whether a reactive power demand of the substation is true; and in a case that the reactive power demand of the substation is true, put a capacitor into use to perform reactive on-site balance control.

7. The control system for AVC substation reactive power optimization assistance according to claim 6, wherein a qualification range of the voltage of the 10 kV bus of the substation is 10.2 kV to 10.7 kV.

8. The control system for AVC substation reactive power optimization assistance according to claim 6, wherein a calculation formula of the power factor is as follows:
$$cos φ = P / S ,$$
wherein cosφ represents the power factor; P represents active power of the main transformation step-down switch; and S represents apparent power of the main transformation step-down switch.

9. A computer device, comprising: a memory, a processor, and a computer program stored on the memory, wherein the computer program, when run by the processor, causes the process to:
determine whether a reactive integrated electric quantity of a main transformer step-down switch of a substation exceeds a set value of reactive integrated electric quantity of the main transformer step-down switch;
in a case that the reactive integrated electric quantity of the main transformer step-down switch of the substation exceeds the set value of reactive integrated electric quantity of the main transformer step-down switch, determine whether voltage of a 10 kV bus of the substation is qualified;
in a case that the voltage of the 10 kV bus of the substation is qualified, determine whether a power factor of a transformer step-down switch is greater than a power factor set value of the main transformer step-down switch;
in a case that the power factor of the transformer step-down switch is greater than the power factor set value of the main transformer step-down switch, determine whether a reactive power demand of the substation is true; and in a case that the reactive power demand of the substation is true, put a capacitor into use to perform reactive on-site balance control.

10. A computer storage medium, having a computer program stored thereon, wherein the computer program, when run by a processor, implements the control method for AVC substation reactive power optimization assistance according to claim 1.

11. The computer device according to claim 9, wherein a qualification range of the voltage of the 10 kV bus of the substation is 10.2 kV to 10.7 kV.

12. The computer device according to claim 9, wherein a calculation formula of the power factor is as follows:
$$cos φ = P / S ,$$
wherein cosφ represents the power factor; P represents active power of the main transformation step-down switch; and S represents apparent power of the main transformation step-down switch.

13. The computer device according to claim 12, wherein a calculation formula of the apparent power is as follows:
$$S = \sqrt{{P}^{2} + {Q}^{2}} ,$$
wherein Q represents reactive power of the main transformation step-down switch.

14. The computer device according to claim 9, wherein the reactive power demand of the substation is determined according to the following condition:
a main transformer ride-through reactive power value is over 90% of a group of capacitance value of the 10 kV bus.

15. The control method for AVC substation reactive power optimization assistance according to claim 1, wherein before determining whether the reactive integrated electric quantity of the main transformer step-down switch of the substation exceeds the set value of reactive integrated electric quantity of the main transformer step-down switch, comprises:
remotely measuring, by the substation, reactive power data of the transformer step-down switch to obtain 24-hour reactive supervisory control and data acquisition (SCADA) integrated electric quantity of the main transformer step-down switch as the reactive integrated electric quantity.

16. The control method for AVC substation reactive power optimization assistance according to claim 5, wherein in a case that reactive power of the transformer step-down switch+the group of capacitance value of the 10 kV bus<a set value, it is determined that the main transformer ride-through reactive power value is over 90% of the group of capacitance value of the 10 kV bus.
